(19) United States
(12) Patent Application Publication
(10) Pub. No.: US 2008/0178164 A1
(43) Pub. Date: Jul. 24, 2008

(54) METHOD, SYSTEM AND APPARATUS TO ASSOCIATE AND TRANSFORM PROCESSES

(75) Inventors: Aaron B. Brown, Croton on Hudson, NY (US); Melissa J. Buco, Amawalk, NY (US); Joseph L. Hellerstein, Seattle, WA (US); Christopher Ward, Glen Ridge, NJ (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/625,499

(22) Filed: Jan. 22, 2007

(51) Int. Cl. G06F 9/45

(52) U.S. Cl. 717/144

(57) ABSTRACT

Described are a method, system and apparatus for the association of an existing process with a reference process and ontology so that the process may be manipulated to the advantage of the process owner. Specifically, once integrated and associated into the process ontology repository and the process graph repository the invention describes how the processes can be expressed so as to show the relationship between process elements at different levels; permit queries against them; provide a way to find similar process elements based on the ontology; facilitate the creation of transformation plans that express how divergent processes can be converged based on similarities identified by the process analysis; associate processes to canonical workflow elements; and retarget process workflows to different workflow engines based on these associations.

### BACKGROUND OF THE INVENTION

1. Field of the Invention

The present invention relates generally to process re-engineering, and more particularly, to providing repeatable service patterns for delivering Information Technology Services that are standardized where possible and customized where required.

2. Background Art

Businesses are beset by conflicting imperatives. On the one hand, they want employees to adhere to standard business processes (often referred to as “best practices”) to provide efficient and low-cost operations as well as to adhere to legal requirements (e.g., Sarbanes-Oxley). On the other hand, businesses want innovation and flexibility, something that often requires deviating from best practices. The inevitable result of this situation is that there are many variations of the same process. Further complicating matters are mergers and acquisitions, which requires that best practices from different businesses be combined.

The foregoing situation means that businesses need a way to converge divergent processes. Further, when processes are automated through the use of a workflow engine, there is often a need to re-target a process from one workflow engine to another.

There are many areas of prior art that are somewhat related to this problem, although it is not obvious to one skilled in the art how to solve the problem. First, there are code structuring and refactoring techniques that generally increase the ease with which processes can be adapted. Examples of this are: (a) specifying command paths that determine which executable is invoked to resolve a command; (b) objective oriented programming, which provides a class hierarchies, inheritance, and abstract methods; and (c) aspect oriented programming, which allows the modification of code based on patterns in its implementation. Unfortunately, none of these techniques help with restructuring divergent processes per se; rather, they provide a framework in which to write processes.

Another potentially related area is design patterns. Design patterns are abstractions about how to write code to gain improvements in flexibility, speed, and other considerations. Processes that are developed in accordance with properly designed patterns can be much easier to adapt and more efficient. However, the problem faced by many businesses is that their processes do not adhere to well formulated guidelines.

One potentially related area is data mining, a capability whereby patterns in processes can be discovered (e.g., the use of a specific web service). While data mining allows an analyst to discover similarities and differences between processes, it does not by itself provide a way to transform divergent processes.

### SUMMARY OF THE INVENTION

An object of this invention is to provide a system and method for converging divergent processes.

Another object of the present invention is to provide repeatable service patterns for delivering Information Technology Services.

These and other objectives are attained with a system for and method of identifying similarities and differences between processes, through the use of an ontology. The system comprises an Ontology Repository providing a specified vocabulary for describing a set of processes, and a Process Annotator for labeling fragments of the processes using said specified vocabulary. The system further comprises a Process Grapher to form graphs of the processes, said graphs showing relationships between the processes at a plurality of levels; and a Process Analyzer and Visualizer to identify similarities and differences between the process elements based on the ontology.

The Process Ontology Repository, as mentioned above, provides a vocabulary for describing the set of processes. For example, processes might be categorized in terms of the IT Infrastructure Library, such as change management, problem management, and configuration management. Indeed, these high level processes can be refined further for considerations such as approval processes. The ontology provides a way to name process fragments as well as to relate higher-level expectations to lower level processes.

The preferred embodiment of the invention uses the Process Ontology Repository in conjunction with a: (a) Process Annotator that labels process fragments based on the ontology; (b) Process Grapher that shows the relationship between process elements at different levels; (c) Process Graph Repository that contains process graphs and workflow associations and supports queries against them; (d) Process Analyzer and Visualizer that provides a way to find similar process elements based on the ontology; (e) Transformation Planner that creates a plan for how divergent processes can be converged based on similarities identified by the Process Analyzer and Visualizer; and (f) Workflow Enabler that retargets process workflows to different workflow engines.

The preferred embodiment of the invention provides a means for an Ontology Designer to update the Process Ontology Repository to describe new processes. A second aspect of the preferred embodiment of the invention details how to transform divergent processes into a single process. A third aspect of the preferred embodiment of the invention prescribes how variants of a single master process are updated when there are changes in the master process.

Considerable benefits accrue from the preferred system and methods of the present invention. Foremost, businesses are able to converge divergent processes while retaining flexibility. Further, businesses are able to operate in a more decentralized way, which provides agility and speed-to-market.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 depicts the elements of a preferred system of the invention.

FIG. 2 displays the steps in a method for updating the Ontology Repository.

FIG. 3 shows a method for converging divergent processes.

FIG. 4 illustrates a method for updating variants of a master process.

FIG. 5 depicts the key concepts that are modeled in the Ontology Repository.

FIG. 6 depicts candidate classifier types that are maintained within the Ontology Repository.

FIG. 7 depicts the key concepts that are modeled in the Process Graph Repository.

FIG. 8 is a diagram of a computer system, which may be used in the practice of this invention.

### DETAILED DESCRIPTION OF THE PREFERRED EMBODIMENTS

The present invention relates to the use of ontology to identify similarities and differences between processes. Ontology is a philosophy of what exists. In computer science ontology is used to model entities of the real world and the relations between them, so as to create common dictionaries for their discussion. Basic concepts of ontology include (i) classes of instances/things, and (ii) relations between the classes, as described hereinbelow. Ontology provides a vocabulary for talking about things that exist. Ontological models are used to talk about “things.” An important vocabulary tool is “relations” between things. An ontology model itself does not include the “things,” but introduces class and relation symbols which can then be used as a vocabulary for talking about and classifying things. Ontology provides a vocabulary for speaking about instances, even before the instances themselves are identified. A class Book is used to say that an instance “is a Book.” A function Author allows one to create clauses “author of” about an instance. A relation Siblings allows one to create statements “are siblings” about instances. Inheritance is used to say, for example, “every Book is a PublishedWork”. Thus all vocabulary appropriate to PublishedWork can be used for Book.

Once an ontology model is available to provide a vocabulary for talking about instances, the instances themselves can be fit into the vocabulary. For each class symbol, C, all instances which satisfy “is a C” are taken to be the set of instances of C, and this set is denoted B(C). Sets of instances are consistent with inheritance, so that B(C₁)⊂B(C₂) whenever C₁ is a subclass of C₂. Relation symbols with domain C₁xC₂x . . . xCₙ correspond to relations on B(C₁)xB(C₂)x . . . xB(Cₙ). Similarly, function symbols with domain B(C₁) and co-domain B(C₂) correspond to functions with domain B(C₁) and co-domain B(C₂). It is noted that if class C₁ inherits from class C, then every instance of C₁ is also an instance of C, and it is therefore known already at the ontology stage that the vocabulary of C is applicable to C₁.

Ontology enables creation of a model of multiple classes and a graph of relationships therebetween. When a class is defined, its attributes are described using handles to related classes. These can in turn be used to look up attributes of the related class, and thus attributes of attributes can be accessed to any depth.

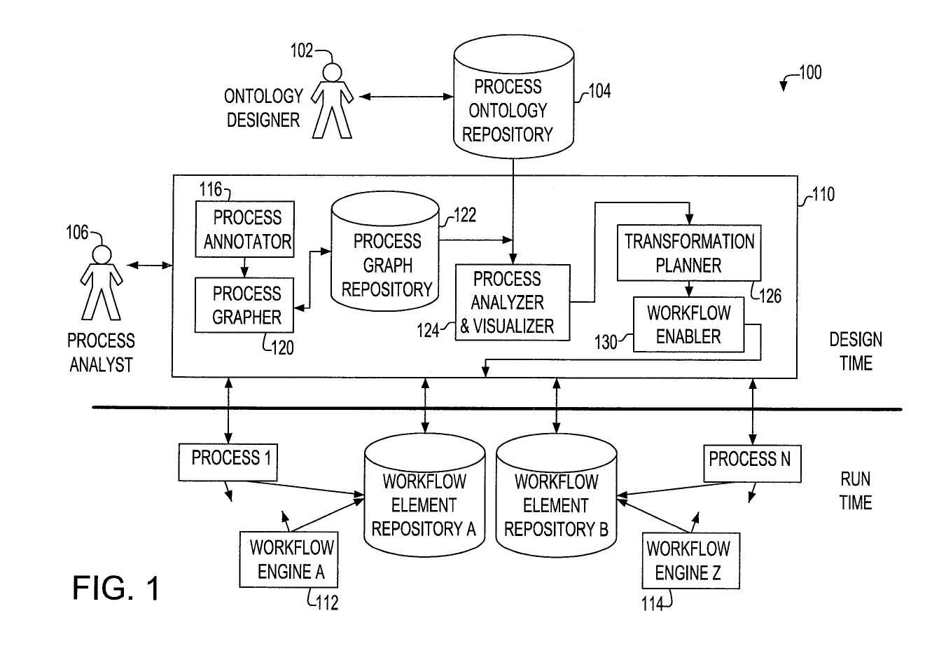

FIG. 1 displays the elements of the preferred system 100 of the invention. Ontology Designers 102 interact with the system by modifying the Process Ontology Repository 104. Process Analysts 106 interacts with the system through the PARE design time environment 110. At runtime, processes execute on workflow engines 112,114. The PARE runtime is comprised of: (a) Process Annotator 116 that labels process fragments based on the ontology; (b) Process Grapher 120 that shows the relationship between process elements at different levels; (c) Process Graph Repository 122 that contains process graphs and supports queries against them; (d) Process Analyzer and Visualizer 124 that provides a way to find similar process elements based on the ontology; (e) Transformation Planner 126 that creates a plan for how divergent processes can be converged based on similarities identified by the Process Analyzer and Visualizer; and (f) Workflow Enabler 130 that retargets process workflows stored in the workflow element repositories to different workflow engines.

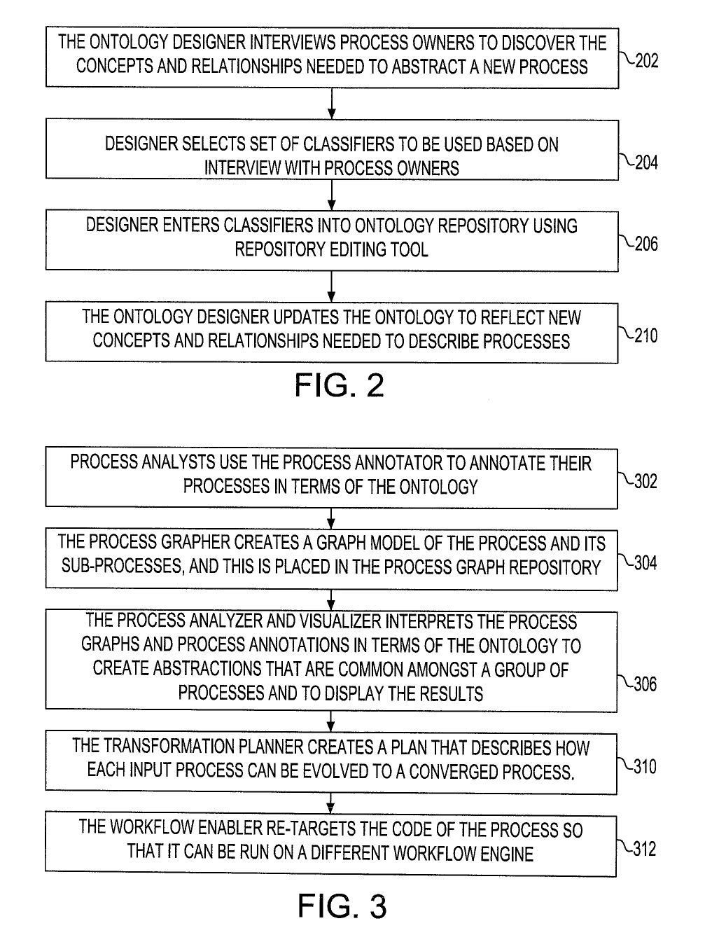

FIG. 2 shows the steps required to update the Process Ontology Repository. In step 202, the Ontology Designer determines the requirements of the representations in the Process Ontology Repository. More specifically, at step 204, the Designer selects a set of classifiers to be used based on interviews with process owners; and, at step 206, the Designer enters classifiers into the ontology repository using a repository-editing tool. In the case in which Ontology Designer is adding details about divergent processes, the Ontology designer may relate the terms used in the divergent processes with the terms used in the best practice process. These relationships may involve set coverage of elements between the two sets of terms or set differences. In step 210, the Ontology Designer performs the updates needed to achieve these requirements.

FIG. 3 details the steps done to converge divergent processes. In Step 302, the Process Analysts characterize processes in terms of the ontology using Process Annotator element of the PARE system. This is accomplished by the Process Analyst associating terms from the ontology repository to the process so as to characterize steps within the process based on the set of classifiers selected by the process analyst. The Process Analysis can associate process steps from a best practices process directly against a divergent process, or can specify that a particular best practices step covers (or is covered by) a set of divergent process steps. In step 304, processes are represented as graphs through automation provided by the Process Grapher. In step 306, the Process Analyzer and Visualizer discover similarities between processes. This is accomplished by comparison between the sets of classifiers used for the divergent process against the best practice process and the relationships that were expressed by the Ontology Designer as described in FIG. 2. The similarities between the processes can be expressed by annotation of either the best practice process with differences from it, or from the divergent process with best practice differences. In step 310, a plan is created for converging divergent processes. This is accomplished by inspection of the differences and, based on designated classifiers (e.g. inputs/outputs), additional process steps introduced/removed or existing process steps altered. In step 312, processes are retargeted to different workflow engines.

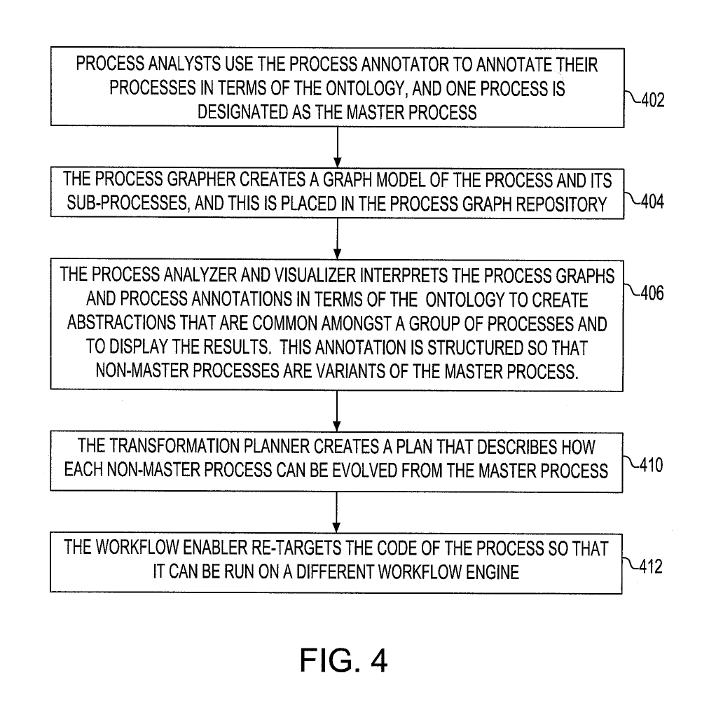

FIG. 4 specifies how variants of a master process are kept in concordance with the master process. In Step 402, Process Analysts characterize processes in terms of the ontology using the Process Annotator element of the PARE system, and they designate one of the processes as the master process. In step 404, processes are represented as graphs through automation provided by the Process Grapher. In step 406, the Process Analyzer and Visualizer discover similarities between the master process and process variants. In step 410, a plan is created for keeping process variants in concordance with the master process. In step 412, processes are retargeted to different workflow engines.

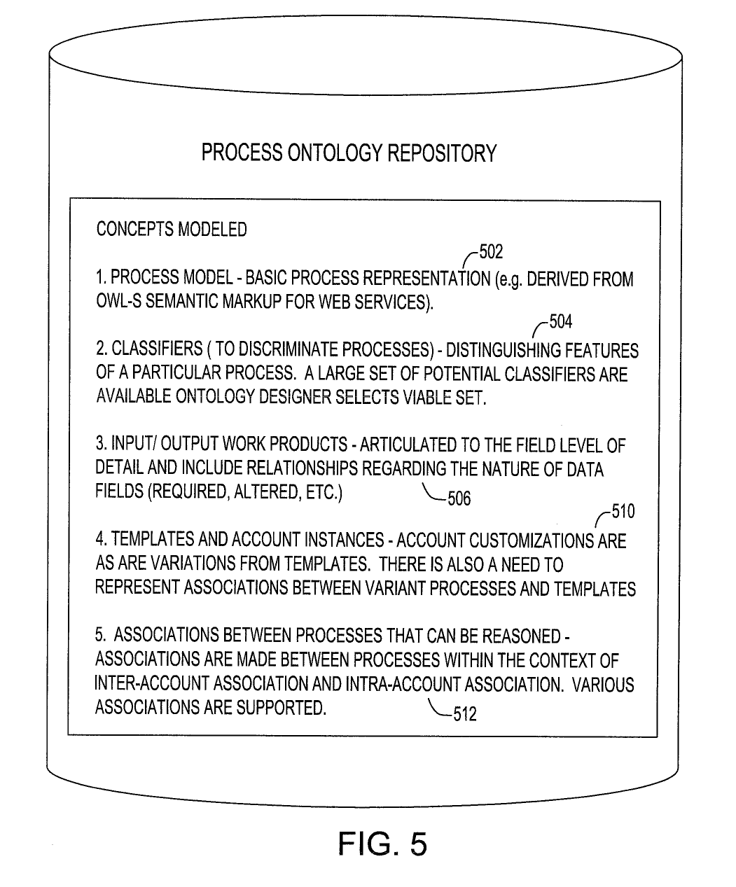

FIG. 5 describes an illustrative set of concepts that are modeled in the Process Ontology Repository. The concepts depicted include the Process Model 502 which defines Basic process representation (e.g. derived from OWL-S Semantic Markup for Web Services); a set of Classifiers 504, which are used to express distinguishing features of a particular process, from which the ontology designer selects a viable set; the input/output work products 506, which are articulated to the field level of detail and include relationships regarding the nature of data fields (required, altered, etc.); the templates and account instances 510, which provide account customizations as variations from templates; represent associations 512 between variant process and template; and associations between processes that can be reasoned, associations are made between processes within the context of inter-account association and intra-account association.

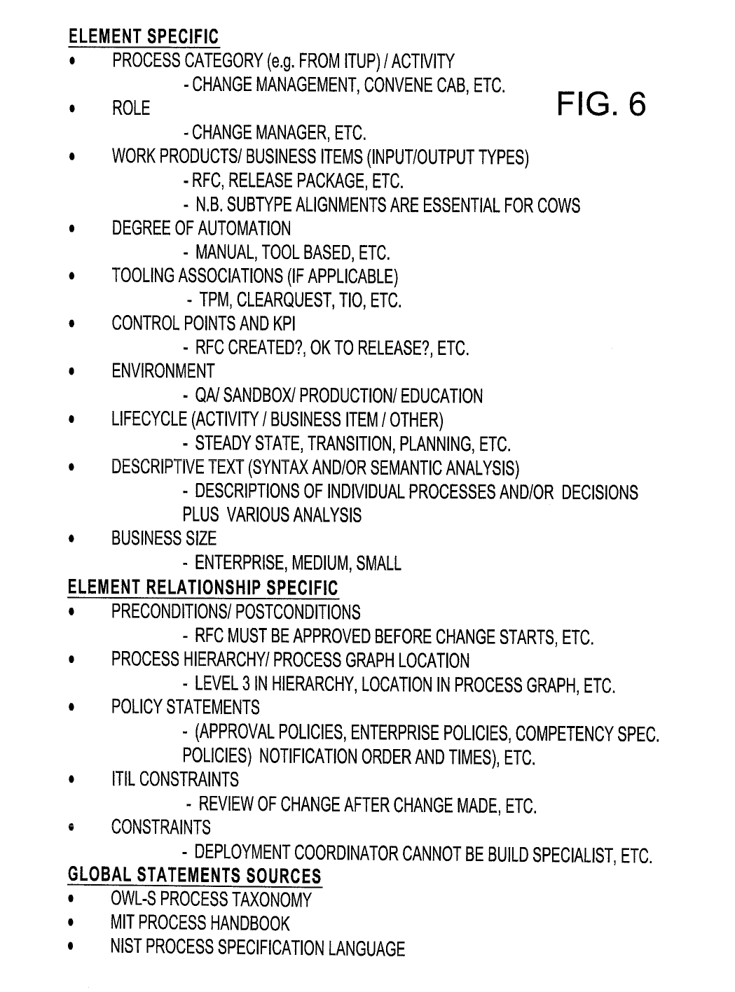

FIG. 6 provides more details on the set of classifiers that can be used to annotate processes including standards domain, roles, and hierarchy level. FIG. 6 shows three types of classifiers: Element Specific; Element Relationship Specific; and Global Statement Sources. Element Specific classifiers includes Process category/activity; Role; Work Products/Business Items; Degree of Automation; Tooling associations; Control Points and KPI; Environment; Lifecycle; Descriptive Text; and Business Size. Element Relationship Specific classifiers include Preconditions/Postconditions; Process Hierarchy/Process Graph Location; Policy Statements; ITTL Constraints; and more general Constraints. The Global Statement Sources classifiers includes, for example, OWL-S Process Taxonomy, MIT Process Handbook, and NIST Process Specification Language.

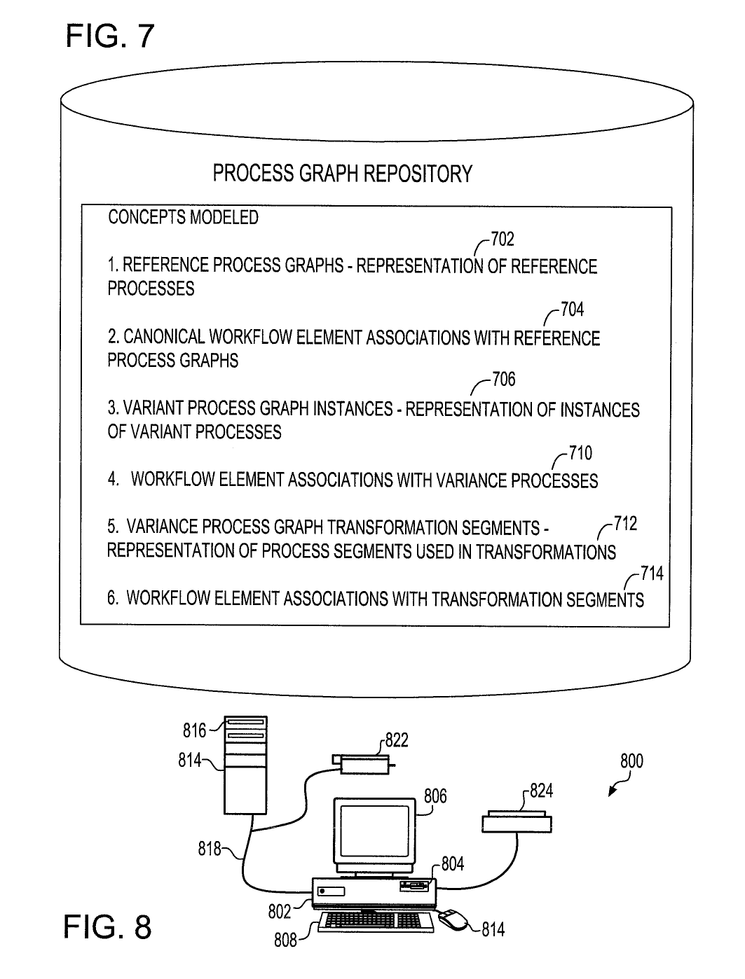

FIG. 7 provides illustrative examples of the concepts that are modeled in the process graph repository. The concepts depicted include reference process graphs 702, which are a representation of reference processes; canonical workflow element associations 704 with reference process graphs (separate associations for different workflow engines); variant process graph instances 706, which provide representation of instances of variant processes; workflow element associations 710 with variance processes; variance process graph transformation segments 712 which provide representation of process segments used in transformations; and workflow element associations 714 with transformation segments.

The method of the present invention will be generally implemented by a computer executing a sequence of program instructions for carrying out the steps of the method and may be embodied in a computer program product comprising media storing the program instructions. Referring to FIG. 8, a computer system 800 is depicted on which the method of the present invention may be carried out. Processing unit 802, houses a processor, memory and other systems components that implement a general purpose processing system that may execute a computer program product comprising media, for example a floppy disc that may be read by processing unit 802 through floppy drive 804.

The program product may also be stored on hard disk drives within processing unit 802 or may be located on a remote system 814 such as a server, coupled to processing unit 802, via a network interface, such as an Ethernet interface. Monitor 806, mouse 814 and keyboard 808 are coupled to processing unit 802, to provide user interaction. Scanner 824 and printer 822 are provided for document input and output. Printer 822, is shown coupled to processing unit via a network connection, but may be coupled directly to processing unit 802. Scanner 824 is shown coupled to processing unit 802 directly, but it should be understood that peripherals may be network coupled or direct coupled without affecting the ability of workstation computer 800 to perform the method of the invention.

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A system for identifying similarities and differences between processes, through the use of an ontology, said system comprising:
an Ontology Repository providing a specified vocabulary for describing a set of processes;
a Process Annotator for labeling fragments of the processes using said specified vocabulary;
a Process Grapher to form graphs of the processes, said graphs showing relationships between the processes at a plurality of levels; and
a Process Analyzer and Visualizer to identify similarities and differences between the process elements based on the ontology.

2. A system according to claim 1, further comprising a Transformation Planner for creating a plan for converging divergent ones of the processes.

3. A system according to claim 2, wherein the Transformation Planner creates the plan for converging the divergent ones of the processes based on similarities between said divergent ones of the processes identified by the Process Analyzer.

4. A system according to claim 1, wherein the processes include workflows and are processed by workflow engines.

5. A system according to claim 4, further comprising a Workflow Enabler to retarget the process workflows, after the processes are changed, from one workflow engine to a different workflow engine.

6. A system according to claim 1, further comprising a Process Graph Repository to contain the process graphs and workflow associations and to support queries against said process graphs and workflow associations.

7. A method of identifying similarities and differences between processes, through use of an ontology, the method comprising the steps of:
providing a specified vocabulary for describing a set of processes;
using the specified vocabulary to develop a respective ontology for each of the processes;
forming an ontology graph for each of the processes; and
analyzing the ontology graphs of the processes to identify similarities and differences between the processes.

8. A method according to claim 7, comprising the further step of converging divergent ones of the processes by reconciling the differences between said divergent ones of the processes.

9. A method according to claim 8, wherein the converging step includes the step of creating a plan for converging said divergent ones of the processes based on similarities between said divergent ones of the processes.

10. A method according to claim 9, wherein the processes include workflows and said workflows are processed by workflow engines, and comprising the further step of retargeting process workflows, after the processes are changed, from one workflow engine to a different workflow engine.

11. A method according to claim 8, wherein the converging step includes the steps of:
designating one of the processes as a master process;
designating others of the processes as process variants, said process variants being variations of the master process; and
keeping said process variants in concordance with the master process.

12. A method according to claim 7, wherein the specified vocabulary is kept in a Process Ontology Repository, and comprising the further step of updating the Process Ontology Repository.

13. A program storage device readable by machine, tangibly embodying a program of instructions executable by the machine to perform a method of identifying similarities and differences between processes, through use of an ontology, the method comprising the steps of:
providing a specified vocabulary for describing a set of processes;
using the specified vocabulary to develop a respective ontology for each of the processes;
forming an ontology graph for each of the processes; and
analyzing the ontology graphs of the processes to identify similarities and differences between the processes.

14. A program storage device according to claim 13, wherein said method comprises the further step of converging divergent ones of the processes by reconciling the differences between said divergent ones of the processes.

15. A program storage device according to claim 14, wherein the converging step includes the step of creating a plan for converging said divergent ones of the processes based on similarities between said divergent ones of the processes.

16. A program storage device according to claim 15, wherein the processes include workflows and said workflows are processed by workflow engines, and the method comprises the further step of retargeting process workflows, after the processes are changed, from one workflow engine to a different workflow engine.

17. A program storage device according to claim 14, wherein the converging step includes the steps of:
designating one of the processes as a master process;
designating others of the processes as process variants, said process variants being variations of the master process; and
keeping said process variants in concordance with the master process.

18. A program storage device according to claim 13, wherein the specified vocabulary is kept in a Process Ontology Repository, and the method comprises the further step of updating the Process Ontology Repository.
